(19) United States
(12) Patent Application Publication
(10) Pub. No.: US 2009/0275476 A1
(43) Pub. Date: Nov. 5, 2009

(54) CRYOSTAT ASSEMBLY

(76) Inventor: Milind Diwakar Atrey, Witney (GB)

Correspondence Address: BLANK ROME LLP, WATERGATE, 600 NEW HAMPSHIRE AVENUE, N.W., WASHINGTON, DC, 20037, US

(21) Appl. No.: 11/817,388

(22) PCT Filed: Feb. 23, 2006
(86) PCT No.: PCT/GB06/00629

§ 371 Date: Jul. 13, 2009

(30) Foreign Application Priority Data
Mar. 2, 2005 (GB) 0504345.0

(51) Int. Cl. H01F 6/04; F25D 19/00; F17C 3/00; F17C 3/10

(52) U.S. Cl. 505/163; 62/51.1

(57) ABSTRACT

A cryostat assembly includes a first thermal shield positioned outside a working volume and a second thermal shield positioned outside the first thermal shield. A first cryocooler has at least two cooling stages operating with He⁴, a first stage of the cryocooler being thermally coupled to the second thermal shield, and a second stage of the first cryocooler being thermally coupled to the first thermal shield. A second cryocooler operates with He³ and has at least one cooling stage, a part of the second cryocooler, warmer than the cooling stage of the second cryocooler, being thermally coupled to the second stage of the first cryocooler.

The invention relates to a cryostat assembly, for example for cooling a working volume containing a magnetic field generating assembly.

There are a number of applications in which it is necessary to cool a working volume to very low temperatures of the order of 2K or less. These typically relate to the use of high field superconducting magnets in applications such as NMR, MRI, ICR, FTICR, and DNP. This is commonly achieved using a bath of liquid ⁴He in which the magnet is submerged. The magnet bath or vessel is commonly cooled to 2.2K, which is just above the superfluid transition temperature, or λ point, of ⁴He (T_{λ}=2.17K).

2.2K is the preferred operating temperature for two reasons. The specific heat capacity of ⁴He peaks at the A point, so it is desirable to operate as near the lambda point as possible to improve the temperature stability of the system. However, it is generally considered undesirable to operate below the λ point. This is because a proportion of the liquid becomes superfluid, with zero viscosity, and it will flow, even against gravity, through the smallest cracks and orifices towards areas of the cryostat at higher temperature, thus causing a large heat leak and increasing boil-off (the so-called “superleak” phenomenon).

In early sub-cooled systems the magnet containing vessel which contained liquid He was simply pumped to a lower pressure, hence gradually evaporating the liquid bath and sub-cooling the magnet. With this simple design it is necessary to warm up the system, and hence de-energise the magnet, when the bath needs re-filling. To avoid this major cost and inconvenience, the lambda point refrigerator was invented by Roubeau and others (“The operation of superconducting magnets at temperatures below 4.2K”, Cryogenics, February 1972, p.44-47, Biltcliffe, Hanley, McKinnon, Roubeau).

Unfortunately, the lambda refrigerator approach utilizes large quantities of Helium which is undesirable.

Cryocoolers are known but none have been able to cool practical systems to temperatures around 2K.

Jiang et al in “A ³He Pulse Tube Cooler Operating Down To 1.3K”, Cryogenics 44 (2004) 809-816 is an experimental paper describing the design of a single stage He³ cryocooler, a warm end of which is coupled to the cold platform of a single stage He⁴ cryocooler. In this way, the He⁴ cryocooler assists the cooling power of a He³ cryocooler. This produces a cooling power at 2.2K of 42 mW. This arrangement and the cooling power it produces is not sufficient for cooling high field magnets as of now but the cooling power could be increased by using a high power He³ compressor. However, this would significantly increase the operating and capital costs of the system.

In accordance with a first aspect of the present invention, a cryostat assembly comprises a first thermal shield positioned outside a working volume;

a second thermal shield positioned outside the first thermal shield;

a first cryocooler having at least two cooling stages operating with He⁴, a first stage of the cryocooler being thermally coupled to the second thermal shield, and the second stage of the first cryocooler being thermally coupled to the first thermal shield;

and a second cryocooler operating with He³ and having at least one, preferably only one, cooling stage, a part of the second cryocooler, warmer than the cooling stage of the second cryocooler, being thermally coupled to the second stage of the first cryocooler.

We have realized that there is a practical way to cool magnets and other components to a working temperature below 4K, whilst achieving an efficient and cost effective operation. This new design is also easily incorporated into the cryostat design of prior art sub-4K cooling systems, reducing the need for an extensive redesign and minimising such costs. In particular, we arrange for the He⁴ cryocooler to cool the first and second thermal shields and an additional He³ cryocooler which is effectively precooled by the second stage of the He⁴ cryocooler. He³ is an expensive coolant and this enables the He³ cryocooler to be minimized in size to keep the operating costs at a practical level whilst still attaining the necessary cooling powers for cooling objects such as magnets at temperatures down to about 1K. For example, cooling powers of the order of 200 mW can be achieved at 2.2K, suitable for cooling a superconducting magnet, for example high field magnets generating fields in excess of 20 T.

In the preferred examples, the second cryocooler is a single stage cryocooler although it is feasible to utilize a second cryocooler with more than one stage.

The first cryocooler typically has two cooling stages only but could have more than two stages. For example, a third stage could be used for cooling part of a system in which the assembly is provided, such as a NMR probe.

The said part of the second cryocooler may be thermally coupled to the second stage of the first cryocooler via a thermal link provided for that purpose. However, preferably, the connection is achieved via the first thermal shield which therefore reduces the complexity of the structure.

Preferably, in order to increase the assistance provided by the first cryocooler to the second cryocooler, another part of the second cryocooler, warmer than the one part, is coupled to the first stage of the first cryocooler. Again, this can be achieved via a separate thermal link or, preferably, via the second thermal shield.

The location and function of the cooling stage of the second cryocooler will depend upon the application. Thus, the cryostat assembly can be used with a recondensing system in which the cooling stage of the second cryocooler is located within a liquid helium containing vessel so as to recondense vaporised liquid helium and thus cool an item such as a superconducting magnet immersed in the liquid helium. Alternatively, the assembly can be used in a cryogen free cryostat. In this case, for example, the object to be cooled is placed in a vacuum and is cooled by conduction.

A further advantage of this invention is that existing cryostat designs can be easily modified to introduce the new cooling system by simply adding and suitably connecting the second cryocooler.

In accordance with a second aspect of the present invention, a magnetic field generating assembly comprises a superconducting magnet; and

a cryostat having a working volume within which the superconducting magnet is located so as to cool the magnet to its working temperature, the cryostat comprising:

a first thermal shield positioned outside the working volume;

a second thermal shield positioned outside the first thermal shield;

a first, single cooling stage cryocooler operating with He⁴, the cooling stage being thermally coupled with the second thermal shield;

a second, single cooling stage cryocooler operating with He³, the cooling stage being thermally coupled with the first thermal shield and a warmer part of the second cryocooler being thermally coupled to the cooling stage of the first cryocooler.

This aspect of the invention provides a practical system for cooling high field magnets (e.g. >20 T) to about 2K.

Applications for cryostat assemblies according to the invention have been mentioned above and include MRI, NMR, ICR, FTICR, and DNP.

Some examples of cryostat assemblies according to the invention will now be described with reference to the accompanying drawings, in which:

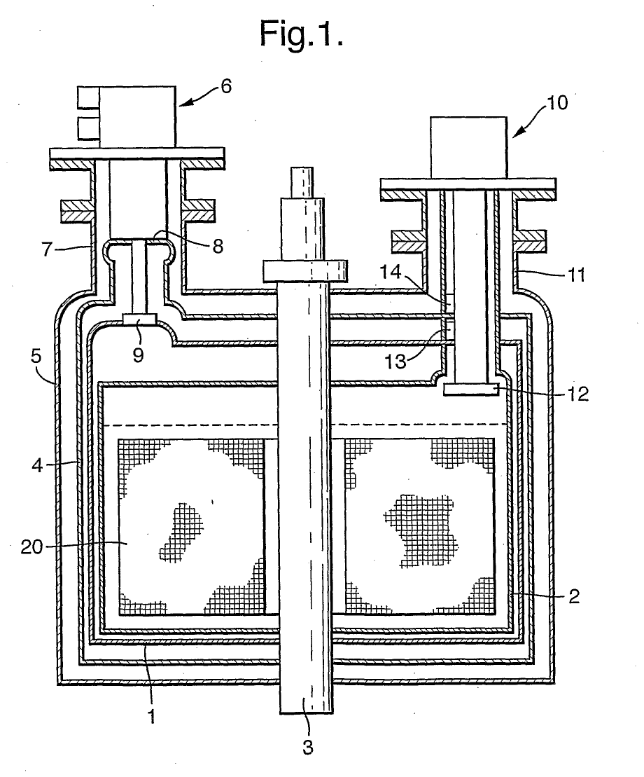

FIG. 1 is a schematic, cross-section through a first example of a cryostat assembly for cooling a superconducting magnet; and,

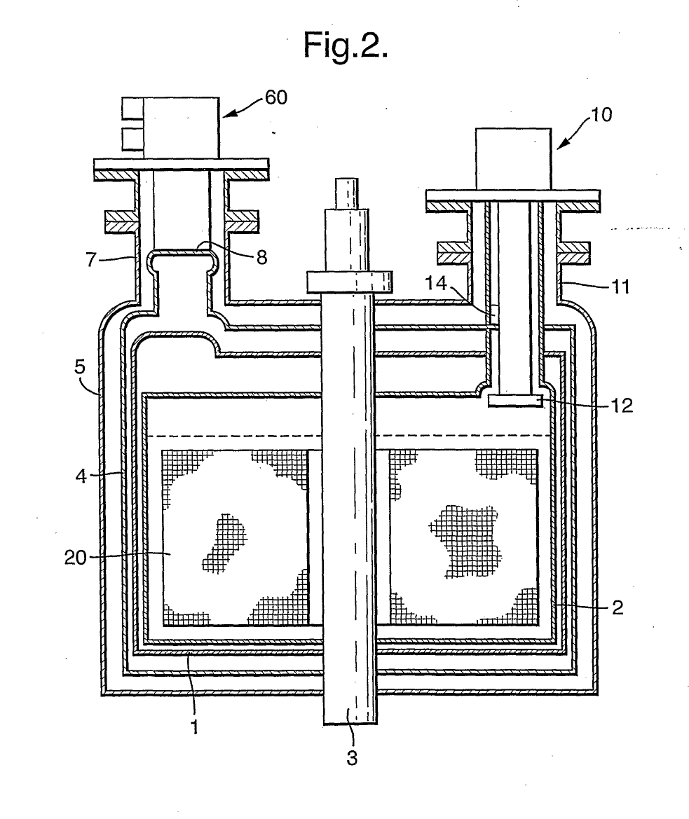

FIG. 2 is a view similar to FIG. 1 but of a second example.

The cryostat assembly shown in FIG. 1 comprises a first thermal shield 1 surrounding a liquid He⁴ containing vessel 2. A superconducting magnet 20 is located in the vessel 2. These components together with the other shields to be described are positioned about a central bore 3 at room temperature and within which a sample to be inspected will be located in use.

A second thermal shield 4 surrounds the first thermal shield 1 and the components are all located within an outer vacuum chamber 5.

A first cryocooler 6 is mounted to a first turret 7 of the outer vacuum chamber 5 and comprises a first cooling stage 8 thermally coupled with the second thermal shield 4, and a second cooling stage 9 thermally coupled with the first thermal shield 1.

The cryocooler 6 is of conventional construction and could comprise a pulse tube refrigerator or Gifford-McMahon refrigerator utilizing He⁴. It is powered by a He⁴ compressor (not shown) operating at room temperature.

In operation, the first stage 8 of the cryocooler 6 maintains the second shield 4 at a temperature of about 50K while the second stage 9 maintains the first shield 1 at a temperature of about 5K.

A second, single stage He³ cryocooler 10 is mounted in a second turret 11 of the outer vacuum chamber 5. This cryocooler 10 has a single cooling stage 12 positioned within the inner vessel 2. A first part 13 of the cryocooler 10, warmer than the cooling stage 12, is thermally coupled with the first thermal shield 1 while a second part 14, warmer than the first part, is thermally coupled to the second shield 4. The links to the parts 13,14 can be provided by copper rings or the like. The cryocooler 10 is powered by a He³ compressor (not shown) at room temperature.

In use, the two stage cryocooler 6 provides a cooling power of about 1W at 4.2-5K at its second stage 9 and about 40W at a temperature of 45-50K at its first stage 8. The second stage 9 is then used to precool the cryocooler 10 via the thermal link to the part 13 of the cryocooler 10. Additional precooling is achieved by the thermal connection of the first stage 8 of the cryocooler 6 with the part 14 of the cryocooler 10. In addition, of course, the first and second stages 8,9 of the cryocooler 6 cool the shields 4,1 respectively. The result is that the cooling stage of the cryocooler 10 will condense helium at about 2.2K within the vessel 2.

This removes the need for components such as a vacuum pump, heat exchangers and expansion valve that are necessary in the prior art cooling system previously described for temperatures of less than 4K. This simplifies the design of the cryostat assembly, reducing costs further.

The He⁴ PTR 6 is in vacuum while the condensing He³ PTR 10 is in gas.

In the example shown in FIG. 2, the basic design of the cryostat is similar to that shown in FIG. 1 and will not be redescribed. Those elements with the same reference numerals as given in FIG. 1 have the same structure and function.

The main difference between the two examples is that only a single stage He⁴ cryocooler 60 is used in place of the cryocooler 6, the cryocooler 60 still being based on the use of He⁴. It is expected that this will enable sufficient cooling power to be provided at the cooling stage 12 of the second He³ cryocooler 10 to maintain the magnet 20 in its superconducting condition. If powerful compressors are used for both the He³ and He⁴ cryocoolers 10,60 then high enough cooling powers should be achieved so that a smaller magnet could be cooled.

1. A cryostat assembly comprising:
a first thermal shield positioned outside a working volume;
a first cryocooler having at least two cooling stages operating with He⁴, a first stage of the cryocooler being thermally coupled to the second thermal shield, and a second stage of the first cryocooler being thermally coupled to the first thermal shield; and
a second cryocooler operating with He³ and having at least one cooling stage, a part of the second cryocooler, warmer than the cooling stage of the second cryocooler, being thermally coupled to the second stage of the first cryocooler.

2. An assembly according to claim 1, wherein said part of the second cryocooler is thermally coupled to the second stage of the first cryocooler via the first thermal shield.

3. An assembly according to claim 1, wherein another part of the second cryocooler, warmer than the one part, is coupled to the first stage of the first cryocooler.

4. An assembly according to claim 3, wherein said another part of the second cryocooler is connected to the first stage of the first cryocooler via the second thermal shield.

5. An assembly according to claim 1, wherein at least one of the first and second cryocoolers comprises a pulse tube refrigerator or a Gifford-McMahon refrigerator.

6. An assembly according to claim 1, further comprising a superconducting magnet located in the working volume.

7. (canceled)

8. A magnetic field generating assembly comprising:
a superconducting magnet; and
a cryostat having a working volume within which the superconducting magnet is located so as to cool the magnet to its working temperature, the cryostat comprising;
a first thermal shield positioned outside the working volume;
a second thermal shield positioned outside the first thermal shield;
a first, single cooling stage cryocooler operating with He⁴, the cooling stage being thermally coupled with the second thermal shield; and
a second, single cooling stage cryocooler operating with He³, and the cooling stage being thermally coupled with the first thermal shield and a warmer part of the second cryocooler being thermally coupled to the cooling stage of the first cryocooler.

9. An assembly according to claim 8, wherein said warmer part of the second cryocooler is thermally coupled to the cooling stage of the first cryocooler via the second shield.

10. (canceled)

11. An assembly according to claim 8, wherein the working volume is cooled to no more than 4.2 K.

12. An assembly according to claim 11, wherein the working volume is cooled to about 2 K.

13. An assembly according to claim 8, wherein the first shield is cooled to substantially 5 K.

14. An assembly according to claim 8, wherein the second shield is cooled to substantially 50 K.

15. An assembly according to claim 8, wherein the cooling stage of the second cryocooler is positioned in a coolant containing vessel within which the working volume is located.

16. An assembly according to claim 15, wherein the coolant in the coolant containing vessel comprises helium.
